(19) United States
(12) Patent Application Publication
(10) Pub. No.: US 2021/0306535 A1
(43) Pub. Date: Sep. 30, 2021

(54) DUAL APERTURE CAMERA

(71) Applicant: Obsidian Sensors, Inc., San Diego, CA (US)

(72) Inventors: John HONG, San Diego, CA (US); Bing WEN, San Diego, CA (US); Tallis CHANG, San Diego, CA (US)

(73) Assignee: Obsidian Sensors, Inc., San Diego, CA (US)

(21) Appl. No.: 17/214,635

(22) Filed: Mar. 26, 2021

Related U.S. Application Data
(60) Provisional application No. 63/000,380, filed on Mar. 26, 2020.

(51) Int. Cl. H04N 5/225

(52) U.S. Cl. CPC H04N 5/2258

(57) ABSTRACT

An imaging device comprising two camera apertures and a method of capturing two fields of view using two camera apertures are disclosed.

### CROSS-REFERENCE TO RELATED APPLICATIONS

This application claims benefit of U.S. Provisional Application No. 63/000,380, filed Mar. 26, 2020, the entire disclosure of which is herein incorporated by reference for all purposes.

### FIELD OF INVENTION

This disclosure generally relates to imaging devices. More specifically, this disclosure relates to an imaging device that includes at least two different camera apertures.

### BACKGROUND OF THE INVENTION

In high performance imaging instruments, large lens zoom assemblies may be needed with focus mechanisms to ensure high quality image capture. Such zoom-capable cameras may be useful on drones, for example, where the imaging can switch between wide field of view for situational awareness and telescopic narrow field for close-up imaging of regions or objects of interest. Although the variable optic allows for flexible use of a same sensor (e.g., a same camera), the user may need to give up one for the other, either wide field or close-ups, but may not have both. Additionally, the zoom lens may often be large and heavy, and precise positioning of multiple optical elements may be required.

Current multiple-camera devices may also be limited. For example, some mobile phones have multiple cameras, but each camera is specialized for a particular field of view. As another example, some security systems have two cameras, a thermal imaging camera and a visible spectrum camera, but the cameras are configured for capturing different imaging information. As yet another example, a computational camera has multiple cameras, and outputs of the individual cameras are combined digitally (e.g., to create a larger image). Neither a zoom-capable camera nor a multiple-camera system allows for capture of both wide field and narrow field simultaneously.

### SUMMARY OF THE INVENTION

An imaging device comprising two camera apertures and a method of capturing two fields of view using two camera apertures are disclosed.

In some embodiments, an imaging device includes: a first thermal camera having a first camera aperture, and a second thermal camera having a second camera aperture. The first camera aperture is larger than the second camera aperture, a second field of view corresponding to the second camera aperture is wider than a first field of view corresponding to the first camera aperture, and the first field of view is a part of the second field of view.

In some embodiments, a method includes: capturing, with a first thermal camera, a first field of view, wherein the first thermal camera includes a first camera aperture; and capturing, with a second thermal camera, a second field of view. The second thermal camera includes a second camera aperture, the first camera aperture is larger than the second camera aperture, the second field of view corresponding to the second camera aperture is wider than the first field of view corresponding to the first camera aperture, and the first field of view is a part of the second field of view.

In some embodiments, a non-transitory computer readable storage medium stores one or more programs, the one or more programs comprising instructions, which when executed by an electronic device with one or more processors and memory, cause the device to perform a method including: capturing, with a first thermal camera, a first field of view, wherein the first thermal camera includes a first camera aperture; and capturing, with a second thermal camera, a second field of view. The second thermal camera includes a second camera aperture, the first camera aperture is larger than the second camera aperture, the second field of view corresponding to the second camera aperture is wider than the first field of view corresponding to the first camera aperture, and the first field of view is a part of the second field of view.

### BRIEF DESCRIPTION OF THE DRAWINGS

FIG. 1 illustrates an exemplary imaging device, according to embodiments of the disclosure.

FIG. 2 illustrates exemplary images taken by an exemplary imaging device, according to embodiments of the disclosure.

FIG. 3 illustrates an exemplary geometry for an exemplary imaging device, according to embodiments of the disclosure.

FIG. 4 illustrates exemplary range estimations for imaging devices, according to embodiments of the disclosure.

FIG. 5 illustrates an exemplary method of operating an exemplary imaging device, according to embodiments of the disclosure.

### DETAILED DESCRIPTION OF EXEMPLARY EMBODIMENTS

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

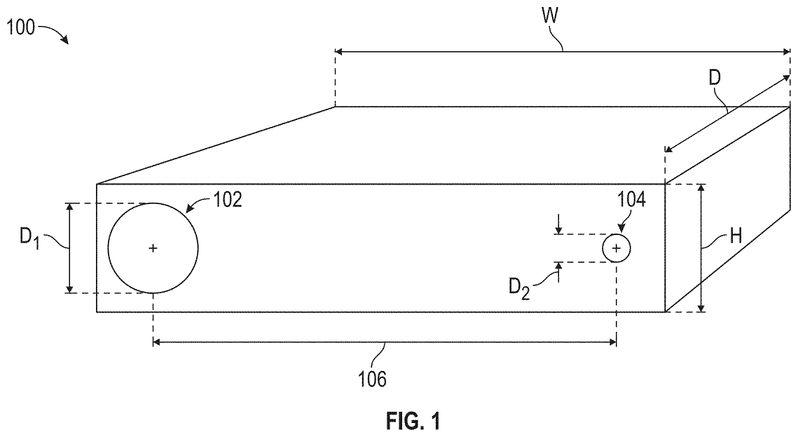

FIG. 1 illustrates an exemplary imaging device 100, according to embodiments of the disclosure. In some embodiments, the imaging device 100 is a dual-aperture thermal camera. For example, the imaging device 100 is a dual-aperture thermal camera. For example, the thermal camera includes bolometers for thermal sensing. As another example, the thermal camera includes bolometers for thermal sensing, and the bolometers are manufactured on a glass substrate. In some embodiments, the imaging device 100 includes VGA format (640H×480V) sensors.

In some embodiments, sensors of the disclosed imaging devices are fabricated using manufacturing technologies described in PCT Publication PCT/US2019/022338 (IMG), the entire disclosure of which is herein incorporated by reference for all purposes. IMG allows for the integration of thin film transistor circuits and MEMS device features on a common glass substrate.

It is understood that resolution of an exemplary sensor is exemplary, and that sensors configured for other graphics standards and resolutions may be used in the imaging device 100. It is also understood that the number of camera apertures is exemplary, and that the imaging device 100 may include more than two camera apertures. In an example, the imaging device 100 has a width W of 184 mm, depth D of 50 mm, and height H of 32 mm. It is understood that the dimensions provided in the disclosed examples are merely exemplary.

In some embodiments, the imaging device 100 includes first camera aperture 102 and second camera aperture 104. In some embodiments, the first camera aperture 102 is associated with a first camera aperture having dimensions of the first camera aperture 102, and the second camera aperture 104 is associated with a second camera aperture having dimensions of the second camera aperture 104. In some embodiments, the first camera aperture 102 and the second camera aperture 104 are separated by a stereo baseline 106 between centers of the two camera apertures. In some embodiments, the stereo baseline 160 is dependent on a dimension of a system using the imaging device 100. For example, the stereo baseline 106 less than the exemplary width W (e.g., less than 184 mm). As another example, the stereo baseline 106 is a width of a vehicle using the imaging device 100 or less than the width of the vehicle.

In some embodiments, the disclosed camera apertures are openings into which electromagnetic radiation is collected. In some embodiments, dimensions of the disclosed camera aperture affect properties (e.g., cone angle of incoming rays, focus) associated with the incoming electromagnetic radiation. In some embodiments, a sensor (e.g., a bolometer) is configured to sense the electromagnetic radiation travelling through a corresponding camera aperture. Although the camera apertures are illustrated as a part of a structural element of the imaging device (e.g., part of the device housing), it is understood that the illustration is not limiting. For example, the camera apertures may be formed by components different than a housing of the imaging device.

In some embodiments, the imaging device 100 advantageously allows for capture of both wide field and narrow field simultaneously, improving upon limitations of existing imaging devices. For example, the imaging device 100 provides a simultaneous wide field of view (e.g., associated with second camera aperture 104) and telephoto magnification of a portion of the wide field (e.g., associated with first camera aperture 102). In some embodiments, as described in more detail herein, the imaging device 100 provides a more accurate range estimate to a target (e.g., an object of interest) that appears in the views of the two camera apertures, compared to a device that has two camera apertures of a same dimension.

In some embodiments, the imaging device 100 can advantageously operate as a fixed focus system, and focus adjustments during operation of the imaging device 100 may not be required. In contrast, a device that does not have such a fixed focus system (e.g., a device with a zoom lens) may require multiple lens elements to be adjusted to maintain focus and set a telephoto level. A device that does not have the fixed focus system may be heavier and/or more costly, compared to the imaging device 100. In some embodiments, the imagine device 100 includes a focus mechanism to compliment the fixed focus system.

In some embodiments, the first camera associated with the first camera aperture 102 (e.g., a camera associated with the telephoto view) is placed on a gimbal mount, allowing movement to the first camera's field of view. Configuring the first camera to move may additionally allow different parts of the wide field view (e.g., a view associated with second camera aperture 104, a view captured by the second camera) to be magnified, and more ranges in the wide of view to be estimated. The ability to move the first camera's field of view may advantageously extend the imaging device's range estimation ability. For example, ranges of more targets (e.g., objects of interest) appearing in the wide field of view may be estimated.

In some embodiments, the first camera aperture 102 is a larger camera aperture configured to capture a smaller field of view (e.g., telephoto magnification), and the second camera aperture 104 is a smaller camera aperture configured to capture a wider field of view. For example, the smaller field of view is 20 degrees, the wider field of view is 60 degrees, and the smaller field of view corresponds to a 3× magnification, compared to the wider field of view. For instance, the first camera aperture 102 is circular, and has a diameter D₁ of 21.8 mm, focal length of 34.5 mm, and a f-number of 1.58; the second camera aperture 104 is circular, and has a diameter D2 of 6.7 mm, focal length of 10.5 mm, and f-number of 1.57. It is understood that the field of view sizes and magnification factor are exemplary, and that the imaging device 100 may be configured for other field of view sizes and magnification factor.

In some embodiments, the first and second camera apertures are each associated with a thermal camera, and at least one visible sensor (e.g., a camera that senses radiation (e.g., light) in the visible spectrum), configured to perform multispectral sensor fusion, is located at a space on the imaging device 100 between the two camera apertures (e.g., a long a direction of the stereo baseline 106).

In some embodiments, a sensor associated with an camera aperture has a 19 μm pitch between neighboring pixels of a sensor (e.g., bolometer pixels). It is understood that described pixel configurations of a sensor (e.g., pixel pitch, number of pixel, pixel arrangements) are merely exemplary.

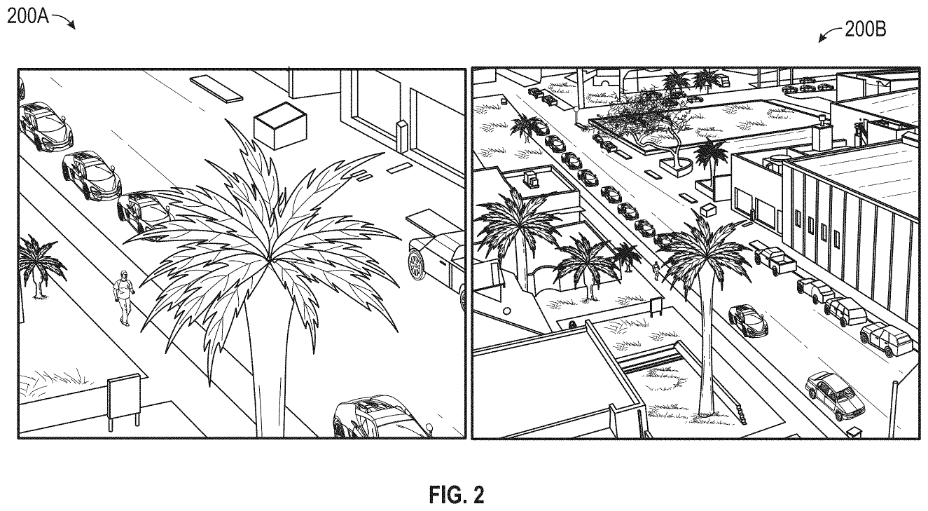

FIG. 2 illustrates exemplary images taken by an exemplary imaging device, according to embodiments of the disclosure. The differences between the two images may illustrate the difference between the focal lengths associated with each of the camera apertures. For example, the left image 200A is taken by a first sensor (e.g., a first camera, a first thermal camera) associated with the first camera aperture 102 (e.g., having a narrower, more magnified field of view), and the right image 200B is taken by a second sensor (e.g., a second camera, a second thermal camera) associated with the second camera aperture 104 (e.g., having a wider field of view). In some embodiments, the images are taken simultaneously by sensors associated with camera apertures 102 and 104 of the imaging device 100.

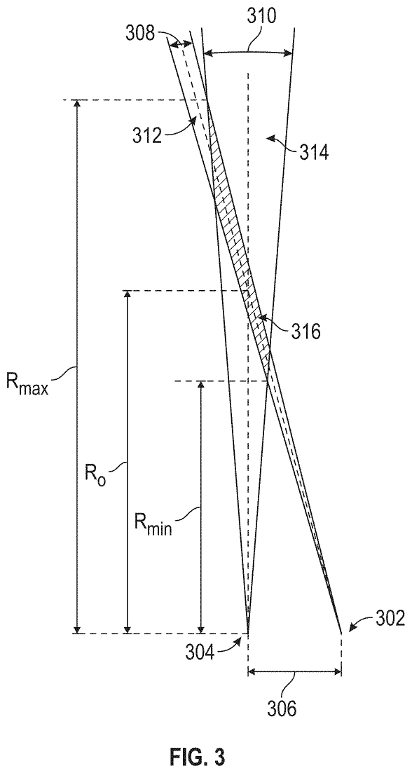

FIG. 3 illustrates an exemplary geometry for an exemplary imaging device, according to embodiments of the disclosure. In some embodiments, the exemplary geometry is a geometry for the imaging device 100. In some embodiments, the imaging device 100 is a dual aperture thermal camera. In some embodiments, the geometry represent an instantaneous field of view associated with each sensor of an imaging device. It is understood that specific geometries described with respect to FIG. 3 are merely exemplary. For instance, in other examples, the first field of view may be wider than the second field of view.

In some embodiments, the geometry includes first point 302, second point 304, stereo baseline 306, a first field of view (e.g., a first instantaneous field of view) represented by angle 308, a second field of view (e.g., a first instantaneous field of view) represented by angle 310, a distance to an object of interest R₀, a range estimation lower bound Rₘᵢₙ, and a range estimation upper bound Rₘₐₓ.

In some embodiments, the first point 302 represents a location (e.g., a location of a pixel) of a first camera aperture of an imaging device (e.g., camera aperture 102), and the second point 304 represents a location (e.g., a location of a pixel) of a second camera aperture of the imaging device (e.g., camera aperture 104). In some embodiments, the first and second points are separated by stereo baseline 306 (e.g., stereo baseline 106).

In some embodiments, the angle 308 angularly represents a first field of view 312 (e.g., an instantaneous field of view (IFOV), a field of view of left image 200A) associated with the first point 302, and the angle 310 angularly represents a second field of view 314 (e.g., an IFOV, a field of view of right image 200B) associated with the second point 304. In some embodiments, the angle 310 is greater than angle 308, meaning that the second field of view is wider than the first field of view. For example, the angle 308 is 20 degrees, and the angle 310 is 60 degrees, meaning that the second field of view is three times wider than the first field of view.

As illustrated, the first field of view 312 intersects the second field of view 314. For example, the first field of view 312 is a magnified portion of the second field of view 314, and an object of interest (e.g., an object in left image 200A) in the field of view is located within the intersection.

In some embodiments, the intersections between the fields of view is trapezoid 316. In some embodiments, a distance from the points 302 and 304 to a point of the trapezoid 316 closest to the points 302 and 304 (e.g., a proximal intersection between the two fields of views) is Rₘᵢₙ, a distance from the points 302 and 304 to a point of the trapezoid 316 farthest from the points 302 and 304 (e.g., a distal intersection between the two fields of views) is Rₘₐₓ, and a distance between the points 302 and 304 to the object of interest is R₀.

In some embodiments, Rₘᵢₙ is a range estimation lower bound, and Rₘₐₓ is a range estimation upper bound. In some embodiments, Rₘᵢₙ and Rₘₐₓ are determined by triangulation (e.g., based on a stereo baseline, an angle of the first field of view, and an angle of the second field of view). For example, if the stereo baseline 306, the angle of the left edge of the first field of view 312, and the angle of the right edge of the second field of view 314 are known, then Rₘᵢₙ can be calculated by triangulation. In some embodiments, the difference between Rₘₐₓ and Rₘᵢₙ is a range estimation error. In some embodiments, the bounds represent maximum and minimum limits to a range estimate that results from analyzing a disparity between two images (e.g., how an object of interest appear to each view, disparity between images 200A and 200B).

In some embodiments, given two stereo views of the same scene (e.g., fields of view 308 and 310), camera calibrations are performed in advance to advantageously simplify the disparity computations. For example, camera calibration may correct for optical misalignments, lens distortion, and/or other non-idealities. In a thermal imaging example, a reference array (e.g., a grid of thermal sources (e.g., heating elements on a flat surface or a flat surface with painted black squares that can absorb infrared light to heat up to a reference value)) may be produced to create thermal contrast (e.g., non-painted surfaces between elements of the reference array). The reference array may be ground truth, and a correspondence between pixels on an image and the reference array may be built up. In some embodiments, the calibration is performed with controlled geometry. In some embodiments, camera to reference array distance is fixed. In some embodiments, the numbers of horizontal and vertical cells on the reference array are fixed. In some embodiments, relative angle between a camera optical axis and a surface normal of a reference array is fixed.

In some examples, an object of interest is in a farther distance, and the object appears isolated (e.g., compared to objects in closer distance), but occupies at least a threshold number of pixels in a camera (e.g., at least ten pixels along a direction). Despite the object's distance from the imaging device, the range of this object may be estimated using imaging device 100. In some embodiments, the imaging device 100 is configured to detect subpixel disparity levels (e.g., sensitivity of 0.05 pixel), and an error in range estimation can be advantageously computed for the object of interest that is farther in distance.

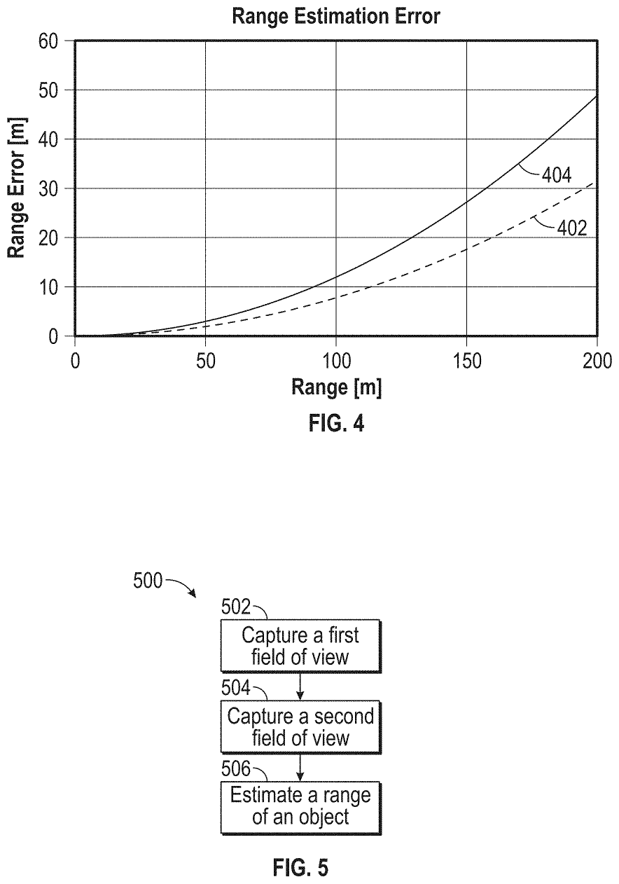

FIG. 4 illustrates exemplary range estimations for imaging devices, according to embodiments of the disclosure. In some embodiments, curve 402 represents a range estimate error (e.g., a difference between Rₘₐₓ and Rₘᵢₙ of a corresponding device for a given distance) for an imaging device having a wider field of view and a narrower field of view. For example, the imaging device 100 has a narrower field of view (e.g., associated with camera aperture 102) with three times the magnification of a wider field of view (e.g., associated with camera aperture 104).

In some embodiments, curve 404 represents a range estimate for an imaging device having two same fields of view. For example, the imaging device has two fields of view that are the same as the wider field of view associated with curve 402. In some embodiments, the imaging devices associated with the two curves have a sensitivity of 0.05 pixel.

In some embodiments, the curves 402 and 404 illustrate that range estimation using an imaging device 100 having a narrower field of view and a wider narrow field of view is advantageously more accurate than an imaging device having two same fields of view. For example, as illustrated with the curves, for a given range (e.g., R₀), a range estimation error associated with curve 402 (e.g., associated a device with having two different fields of view) is less than a range estimation error associated with curve 404 (e.g., associated with a device having two same fields of view). As an example, at a range of 100 m, the range estimation error (e.g., difference between Rₘₐₓ and Rₘᵢₙ) is less than 10 m for an imaging device having a narrower field of view and a wider narrow field of view, but is greater than 10 m for an imaging device having two same fields of view.

In some embodiments, the range estimation error increases as the range distance increases (e.g., a distance between opposing corners of the trapezoid 316 increases). As illustrated, a difference between the range estimation errors become bigger as the range increases. That is, the imaging device 100 having a narrower field of view and a wider narrow field of view is additionally more accurate than an imaging device having two same fields of view as the range increases.

FIG. 5 illustrates an exemplary method 500 of operating an exemplary imaging device, according to embodiments of the disclosure. In some embodiments, the method 500 is a method of operating the imaging device 100. In some embodiments, the method 500 includes a method of generating images described with respect to FIG. 2. In some embodiments, the method 500 includes a method of range estimate described with respect to FIG. 3 or 4.

Although the method 500 is illustrated as including the described steps, it is understood that different order of steps, additional steps, or less steps may be performed to operate an exemplary imaging device without departing from the scope of the disclosure. Some examples and exemplary advantages associated with method 500 are described with respect to FIGS. 1-4. For brevity, these examples and advantages would not be described again.

In some embodiments, the method 500 includes capturing, with a first thermal camera, a first field of view (step 502), and the first thermal camera includes a first camera aperture. For example, a first field of view (e.g., image 200A, field of view 312) is captured by a first thermal camera of the imaging device 100, and the first thermal camera includes the first camera aperture 102.

In some embodiments, the method 500 includes capturing, with a second thermal camera, a second field of view (step 504), and the second thermal camera includes a second camera aperture. For example, a second field of view (e.g., image 200B, field of view 314) is captured by a second thermal camera of the imaging device 100, and the second thermal camera includes the second camera aperture 104. In some embodiments, the first field of view and the second field of view are captured simultaneously. For example, the first field of view associated with camera aperture 102 (e.g., image 200A) and the second field of view associated with camera aperture 104 (e.g., image 200B) are captured simultaneously by imaging device 100. In some embodiments, the first thermal camera, the second thermal camera, or both the first and second thermal cameras comprise bolometers, as described with respect to FIGS. 1-4.

In some embodiments, the first camera aperture is larger than the second camera aperture, the second field of view corresponding to the second camera aperture is wider than a first field of view corresponding to the first camera aperture, and the first field of view is a part of the second field of view. For example, the first camera aperture 102 is larger than the second camera aperture 104, the second field of view corresponding to the second camera aperture 104 (e.g., image 200B, field of view 314) is wider than a first field of view corresponding to the first camera aperture 102 (e.g., image 200A, field of view 312), and the first field of view is a part of the second field of view (e.g., image 200A is a part of image 200B, a field of view 312 is a part of a field of view 314).

In some embodiments, the method 500 includes estimating a range of an object in the first field of view based on: a distance between (1) the first thermal camera, the second thermal camera, or both the first and second thermal cameras and (2) a proximal intersection between the first field of view and the second field of view, and a distance between (1) the first thermal camera, the second thermal camera, or both the first and second thermal cameras and (2) a distal intersection between the first field of view and the second field of view (step 506). For example, as described with respect to FIG. 3, the range of an object at a distance R₀ from a first thermal camera, a second thermal camera, or an imaging device is estimated based on Rₘₐₓ and Rₘᵢₙ.

In some embodiments, the distance between the first thermal camera, the second thermal camera, or both the first and second thermal cameras and the proximal intersection between the first field of view and the second field of view is a minimum of the range (e.g., Rₘᵢₙ), and the distance between the first thermal camera, the second thermal camera, or both the first and second thermal cameras and the distal intersection between the first field of view and the second field of view is a maximum of the range (e.g., Rₘₐₓ). In some embodiments, the method includes calculating the minimum of the range and the maximum of the range by triangulation based on a stereo baseline, an angle of the first field of view, and an angle of the second field of view.

In some embodiments, a magnification of the first field of view is greater than a magnification of the second field of view. For example, a magnification of the first field of view (e.g., associated with camera aperture 102) is three times greater than a magnification of the second field of view (e.g., associated with camera aperture 104).

In some embodiments, the object is in the first field of view, the magnification of the object in the first field of view is greater than the magnification of the object in the second field of view, and the method 500 includes adjusting for the magnification difference of the object between the two fields of view. For example, the object is in the first field of view associated with camera aperture 102 (e.g., image 200A). The magnification of the object in the first field of view is three times greater than the magnification of the object in the second field of view. In some embodiments, the imaging device is configured to adjust for the three times magnification difference of the object between the two fields of view.

In some embodiments, the method includes moving the first thermal camera relative to the second thermal camera comprising moving the first field of view within the second field of view. For example, the first thermal camera (e.g., associated with camera aperture 102) of the imaging device 100 is moved, and moving the first thermal camera moves the first field of view (e.g., a field of view of the first thermal camera) within a second field of view (e.g., a wider field of view of a second thermal camera, compared to the field of view of the first thermal camera). In some embodiments, the first thermal camera is mounted on a gimbal mount, and the gimbal mount is configured to move the first thermal camera.

In some embodiments, a non-transitory computer readable storage medium stores one or more programs, and the one or more programs includes instructions. When the instructions are executed by an electronic device (e.g., imaging device 100, a device controlling the imaging device 100) with one or more processors and memory, the instructions cause the electronic device to perform the methods described with respect to FIGS. 1-5.

In one aspect, an imaging device includes: a first thermal camera having a first camera aperture, and a second thermal camera having a second camera aperture. The first camera aperture is larger than the second camera aperture, a second field of view corresponding to the second camera aperture is wider than a first field of view corresponding to the first camera aperture, and the first field of view is a part of the second field of view.

In one aspect, a method includes: capturing, with a first thermal camera, a first field of view, wherein the first thermal camera includes a first camera aperture; and capturing, with a second thermal camera, a second field of view. The second thermal camera includes a second camera aperture, the first camera aperture is larger than the second camera aperture, the second field of view corresponding to the second camera aperture is wider than the first field of view corresponding to the first camera aperture, and the first field of view is a part of the second field of view.

In one aspect, a non-transitory computer readable storage medium stores one or more programs, the one or more programs comprising instructions, which when executed by an electronic device with one or more processors and memory, cause the device to perform a method including: capturing, with a first thermal camera, a first field of view, wherein the first thermal camera includes a first camera aperture; and capturing, with a second thermal camera, a second field of view. The second thermal camera includes a second camera aperture, the first camera aperture is larger than the second camera aperture, the second field of view corresponding to the second camera aperture is wider than the first field of view corresponding to the first camera aperture, and the first field of view is a part of the second field of view.

Those skilled in the art will recognize that the systems described herein are representative, and deviations from the explicitly disclosed embodiments are within the scope of the disclosure. For example, some embodiments include additional sensors or cameras, such as cameras covering other parts of the electromagnetic spectrum, can be devised using the same principles.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

We claim:

1. An imaging device, comprising:
a first thermal camera having a first camera aperture, and
a second thermal camera having a second camera aperture, wherein:
the first camera aperture is larger than the second camera aperture,
a second field of view corresponding to the second camera aperture is wider than a first field of view corresponding to the first camera aperture, and
the first field of view is a part of the second field of view.

2. The device of claim 1, wherein the first thermal camera, the second thermal camera, or both the first and second cameras comprise bolometers.

3. The device of claim 1, wherein a magnification of the first field of view is greater than a magnification of the second field of view.

4. The device of claim 3, wherein, when an object is in the first field of view:
the magnification of the object in the first field of view is greater than the magnification of the object in the second field of view, and
the device is configured to adjust for the magnification difference of the object between the two fields of view.

5. The device of claim 1, wherein, when an object is in the first field of view:
a minimum range estimate, by the device, of the object is a distance between the device and a proximal intersection between the first field of view and the second field of view, and
a maximum range estimate, by the device, of the object is a distance between the device and a distal intersection between the first field of view and the second field of view.

6. The device of claim 1, wherein:
the first thermal camera is configured to move relative to the second thermal camera, and
the movement of the first thermal camera corresponds to a movement of the first field of view within the second field of view.

7. The device of claim 6, wherein the first thermal camera is mounted on a gimbal mount.

8. The device of claim 1, wherein the first thermal camera and the second thermal camera are configured to respectively capture the first field of view and the second field of view simultaneously.

9. A method, comprising:
capturing, with a first thermal camera, a first field of view, wherein the first thermal camera includes a first camera aperture; and
capturing, with a second thermal camera, a second field of view, wherein:
the second thermal camera includes a second camera aperture,
the first camera aperture is larger than the second camera aperture,
the second field of view corresponding to the second camera aperture is wider than
the first field of view corresponding to the first camera aperture, and
the first field of view is a part of the second field of view.

10. The method of claim 9, further comprising estimating a range of an object in the first field of view based on:
a distance between (1) the first thermal camera, the second thermal camera, or both the first and second thermal cameras and (2) a proximal intersection between the first field of view and the second field of view, and
a distance between (1) the first thermal camera, the second thermal camera, or both the first and second thermal cameras and (2) a distal intersection between the first field of view and the second field of view.

11. The method of claim 10, wherein:
a minimum of the range is the distance between (1) the first thermal camera, the second thermal camera, or both the first and second thermal cameras and (2) the proximal intersection between the first field of view and the second field of view, and
a maximum of the range is the distance between (1) the first thermal camera, the second thermal camera, or both the first and second thermal cameras and (2) the distal intersection between the first field of view and the second field of view.

12. The method of claim 11, further comprising calculating the minimum of the range and the maximum of the range by triangulation based on a stereo baseline, an angle of the first field of view, and an angle of the second field of view.

13. The method of claim 9, wherein the first thermal camera, the second thermal camera, or both the first and second cameras comprise bolometers.

14. The method of claim 9, wherein a magnification of the first field of view is greater than a magnification of the second field of view.

15. The method of claim 14, wherein, when the object is in the first field of view:
the magnification of the object in the first field of view is greater than the magnification of the object in the second field of view, and
the method further comprises adjusting for the magnification difference of the object between the two fields of view.

16. The method of claim 9, further comprising moving the first thermal camera relative to the second thermal camera comprising moving the first field of view within the second field of view.

17. The method of claim 16, wherein the first thermal camera is mounted on a gimbal mount.

18. The method of claim 9, wherein the first field of view and the second field of view are captured simultaneously.

19. A non-transitory computer readable storage medium storing one or more programs, the one or more programs comprising instructions, which when executed by an electronic device with one or more processors and memory, cause the device to perform a method comprising:
capturing, with a first thermal camera, a first field of view, wherein the first thermal camera includes a first camera aperture; and
capturing, with a second thermal camera, a second field of view, wherein:
the second thermal camera includes a second camera aperture,
the first camera aperture is larger than the second camera aperture,
the second field of view corresponding to the second camera aperture is wider
than the first field of view corresponding to the first camera aperture, and
the first field of view is a part of the second field of view.

20. The non-transitory computer readable storage medium of claim 19, wherein the method further comprises estimating a range of an object in the first field of view based on an intersection, the intersection based on:
a distance between the first thermal camera, the second thermal camera, or both the first and second thermal cameras and a proximal intersection between the first field of view and the second field of view, and
a distance between the first thermal camera, the second thermal camera, or both the first and second thermal cameras and a distal intersection between the first field of view and the second field of view.
